(19) United States
(12) Patent Application Publication
(10) Pub. No.: US 2023/0419476 A1
(43) Pub. Date: Dec. 28, 2023

(54) IMAGE DEFECT IDENTIFICATION METHOD AND IMAGE ANALYSIS DEVICE

(71) Applicant: VIVOTEK INC., New Taipei City (TW)

(72) Inventor: Chung-Kai Chang, New Taipei City (TW)

(73) Assignee: VIVOTEK INC., New Taipei City (TW)

(21) Appl. No.: 18/210,072

(22) Filed: Jun. 14, 2023

(30) Foreign Application Priority Data
Jun. 24, 2022 (TW) 111123682

(51) Int. Cl. G06T 7/00; G06T 5/00

(52) U.S. Cl. CPC G06T 7/001; G06T 5/002

(57) ABSTRACT

An image defect identification method is applied to an image analysis device with an image receiver and an operation processor. The image defect identification method divides a detection image acquired by the image receiver into a plurality of pixel groups, transforms one of the plurality of pixel groups into a distribution curve, compares the distribution curve with a reference curve, and determines an area of the detection image conforming to a specific section of the distribution curve has defect when a difference between the specific section of the distribution curve and a related section of the reference curve is greater than a predefined threshold.

### BACKGROUND OF THE INVENTION

### 1. Field of the Invention

The present invention relates to an image defect identification method and an image analysis device, and more particularly, to an image defect identification method and an image analysis device capable of automatically finding out dirty or damaged areas in the captured image.

### 2. Description of the Prior Art

When the camera is manufactured or used, dust may accidentally fall into the casing and stay on the lens or the optical sensor, which results in dark spots on the captured image and reduces the image quality. Conventional solution may manually check the captured image to visually identify whether the dark spots are existed in the captured image, which is extremely labor-intensive. If the lens or the optical sensor is polluted by dust, there has no automatic identification technology that can accurately and rapidly find out the image defect. Besides, the conventional image dirt identification technology divides the captured image into grids, and computes the average brightness of each grid, and then compares the average brightness of each grid with the average brightness of adjacent grids. If the average brightness of one grid is lower than the average brightness of adjacent grids, the area where the foresaid grid is located is considered in dirty. However, due to configuration of the optical elements, brightness of the edge area or the corner area of the captured image is low, which is often misjudged in dirty; the captured image needs to be further divide into smaller grids for small dirt identification, but the smaller grids are easy to be affected by the image correction algorithm and cause a false judgment. Therefore, design of an image analysis technology capable of automatically finding out dirty or damaged areas on the image is an important issue in the surveillance equipment industry.

### SUMMARY OF THE INVENTION

The present invention provides an image defect identification method and an image analysis device capable of automatically finding out dirty or damaged areas in the captured image for solving above drawbacks.

According to the claimed invention, an image defect identification method is applied to an image analysis device with an image receiver and an operation processor. The image defect identification method includes dividing a detection image acquired by the image receiver into a plurality of pixel groups, transforming one of the plurality of pixel groups into a distribution curve, comparing the distribution curve with a reference curve, and determining an area of the detection image conforming to a specific section of the distribution curve has defect when a difference between the specific section of the distribution curve and a related section of the reference curve is greater than a predefined threshold.

According to the claimed invention, an image analysis device includes an image receiver and an operation processor. The image receiver is adapted to acquire a detection image. The operation processor is electrically connected with the image receiver in a wire manner or in a wireless manner, and adapted to divide the detection image into a plurality of pixel groups, transform one of the plurality of pixel groups into a distribution curve, compare the distribution curve with a reference curve, and determine an area of the detection image conforming to a specific section of the distribution curve has defect when a difference between the specific section of the distribution curve and a related section of the reference curve is greater than a predefined threshold.

The image defect identification method and the related image analysis device of the present invention can sequentially scan all rows or all columns of pixels on the detection image, and compute the distribution curve and the reference curve acquired from the transformation of the filter matrix or the analysis of the intensity distribution applied to each row or each column of pixels for comparison. The reference curve and the distribution curve may be acquired from the same detection image, or the reference curve may be acquired from another reference image rather than the detection image; however, the distribution curve and the reference curve can be preferably acquired from the same image. The image defect (such as the dark spot) may change intensity of related pixels on the detection image, which results in the unsmooth curve, so that two filter matrices of different sizes that both have a curve smoothing effect can be utilized to generate two curves which has different degrees of smoothness in the unsmooth area. The section difference between the distribution curve and the reference curve can be compared to analyze a range and a degree of the defect of the detection image, so as to effectively determine whether the lens or the image sensor of the camera is a defective product.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an image analysis device according to an embodiment of the present invention.

FIG. 2 is a flow chart of an image defect identification method according to the embodiment of the present invention.

FIG. 3 is a diagram of a detection image according to the embodiment of the present invention.

FIG. 4 and FIG. 5 are diagrams of curves transformed by the detection image in different applications according to the embodiment of the present invention.

FIG. 6 is a diagram of a curve transformed from the detection image according to a second embodiment of the present invention.

FIG. 7 is an intensity distribution diagram of one pixel group of the detection image according to the second embodiment of the present invention.

### DETAILED DESCRIPTION

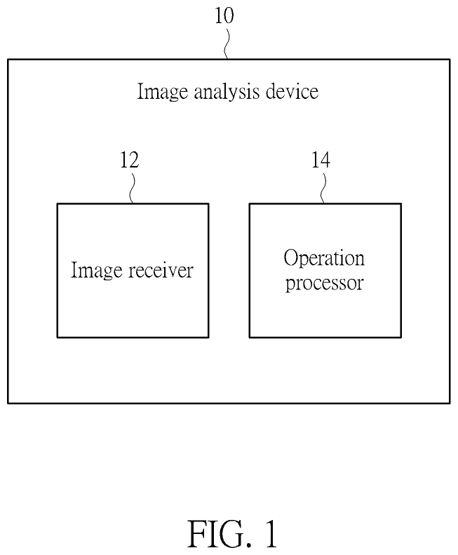

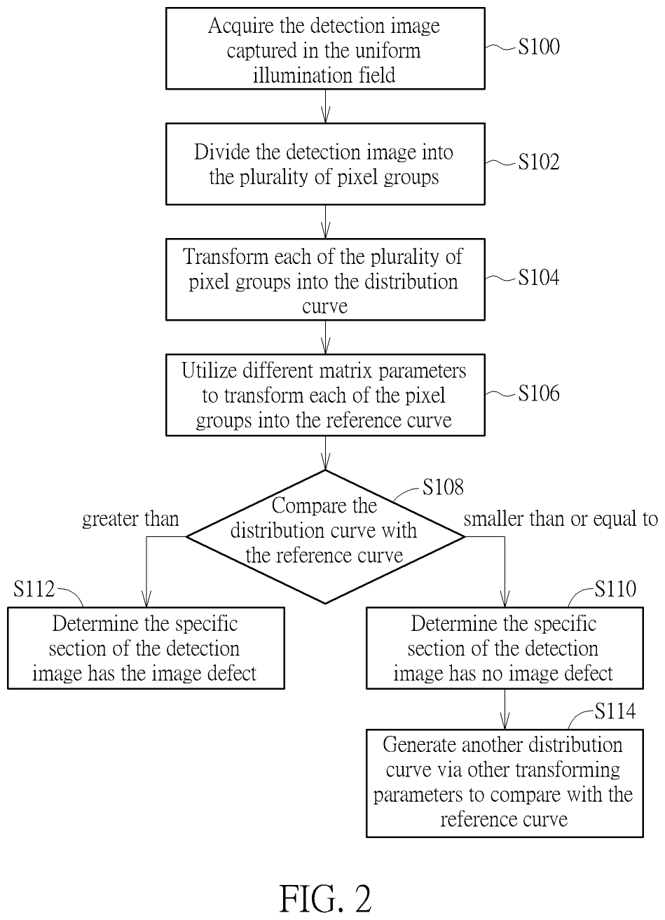

Please refer to FIG. 1 and FIG. 2. FIG. 1 is a functional block diagram of an image analysis device 10 according to an embodiment of the present invention. FIG. 2 is a flow chart of an image defect identification method according to the embodiment of the present invention. The image defect identification method illustrated in FIG. 2 can be suitable for the image analysis device 10 shown in FIG. 1. The image analysis device 10 can include an image receiver 12 and an operation processor 14. The image receiver 12 can acquire a detection image via direct capturing process, or can be connected to an external camera to acquire the detection image captured by the external camera; application of the image receiver 12 depends on an actual demand. The operation processor 14 can be connected to the image receiver 12 in a wire manner or in a wireless manner, and used to analyze the detection image for execution of the image defect identification method.

The image analysis device 10 can be a camera communicated with the personal computer, or an external apparatus communicated with the camera; the camera can be replaced by any apparatus with an image capturing function. The lens or the image sensor of the camera may be dirty due to long-term use or environmental pollution, or some sensing units of the image sensor may be damaged due to accident. The image analysis device 10 can analyze image content of the detection image provided by the camera to automatically and rapidly find out the image defect. The image defect may be dust stayed on the lens or the image sensor, or abrasion of the lens damaged by hard material, or invalid of the sensing units of the image sensor. Any image defect that can generate an obvious dark spot on the detection image can belong to an application scope of the image defect identification method of the present invention.

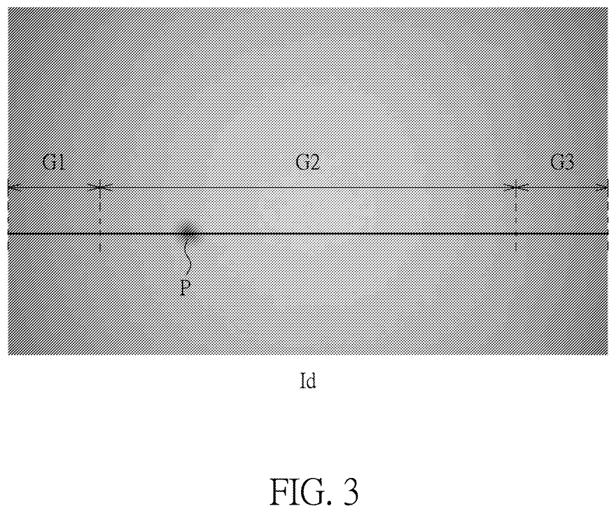

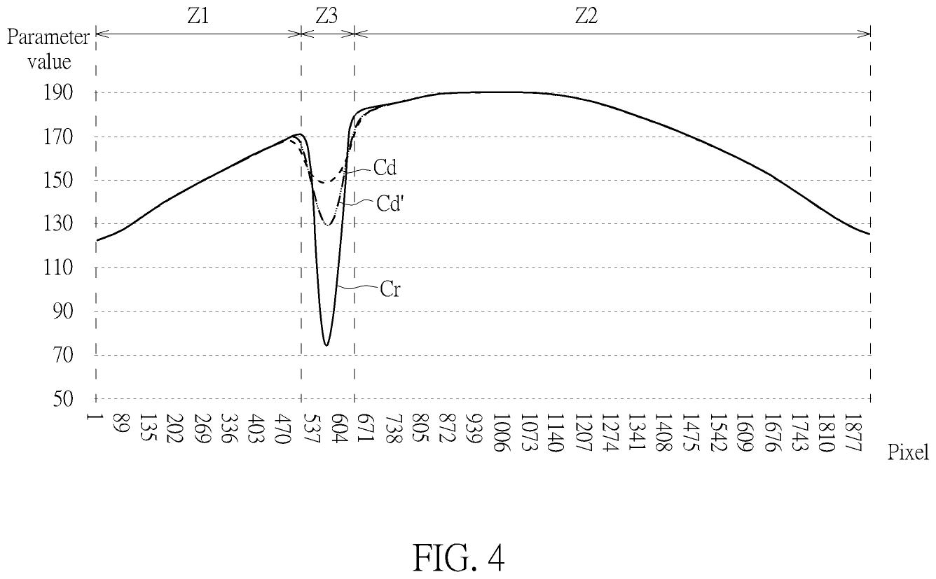

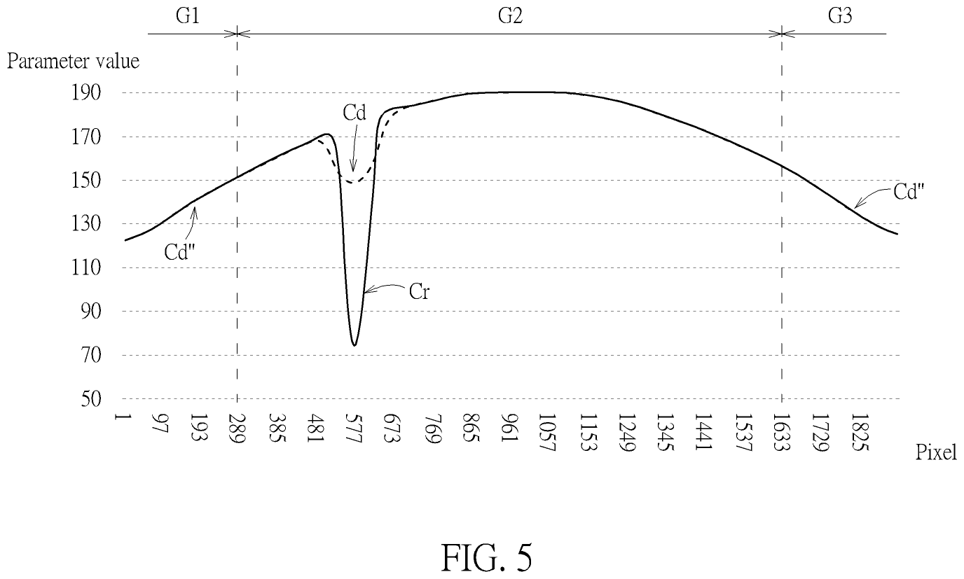

Please refer to FIG. 2 to FIG. 5. FIG. 3 is a diagram of a detection image Id according to the embodiment of the present invention. FIG. 4 and FIG. 5 are diagrams of curves transformed by the detection image Id in different applications according to the embodiment of the present invention. First, step S100 can be executed, and the image receiver 12 can acquire the detection image Id captured in the environment with a uniform illumination field. The uniform illumination field can be interpreted as the camera is set inside the environment where ambient light is stable without severe change; there may have no object put inside a capturing area of the camera, and therefore the image defect can be more obvious than the image background. Later, step S102 can be executed, and the operation processor 14 can divide the detection image Id into a plurality of pixel groups; for example, a plurality of pixel rows or a plurality of pixel columns inside the detection image Id can be defined as the plurality of pixel groups, and an actual application of the pixel group can depend on a design demand.

Then, step S104 and step S106 can be executed that the operation processor 14 can transform each of the plurality of pixel groups into a distribution curve Cd by each pixel row or each pixel column, and the same matrix model but different matrix parameters can be utilized to transform each of the pixel groups into a reference curve Cr. In the first embodiment, the operation processor 14 can utilize the Gaussian filter matrix, the mean filter matrix, the median filter matrix, the bilateral filter matrix, or any applicable filter matrix to generate the distribution curve Cd and the reference curve Cr. As shown in FIG. 4, the distribution curve Cd can be generated by the filter matrix with a larger size, and curve distribution of a segment on the curve overlapped with the image defect is relatively flat; the reference curve Cr can be generated by the filter matrix with a smaller size, and the curve distribution of the segment on the curve overlapped the image defect may produce steep local change.

Then, step S108 can be executed to compare the distribution curve Cd with the reference curve Cr. If a difference between a specific section of the distribution curve Cd and a related section of the reference curve Cr is smaller than or equal to a predefined threshold, such as the first section Z1 and the second section Z2, the distribution curve Cd and the reference curve Cr may have a high degree of overlapping, and step S110 can be executed to determine an area of the detection image Id conforming to the specific section has no image defect. If the difference between the specific section of the distribution curve Cd and the related section of the reference curve Cr is greater than the predefined threshold, such as the third section Z3 shown in FIG. 4, step S112 can be executed to determine the area of the detection image Id conforming to the specific section has the image defect. The image defect may be a dark spot P shown in FIG. 3.

In the first embodiment, the image defect identification method can utilize the same matrix model but different matrix parameters to transform each of the pixel groups into the distribution curve Cd and the reference curve Cr. If the difference between the specific section of the distribution curve Cd and the related section of the reference curve Cr is smaller than or equal to the predefined threshold, step S114 can be optionally executed after step S110 to generate the distribution curve Cd′ via the filter matrix with other transforming parameters, and further to compare the distribution curve Cd′ with the reference curve Cr for determining whether the difference between the specific sections of two curves is greater than, smaller than or equal to the predefined threshold, so as to verify whether the area of the detection image Id conforming to the foresaid section has the image defect. In the present invention, the filter matrix applied to the distribution curve Cd′ can preferably have the size greater than the size of the filter matrix applied to the reference curve Cr, and smaller than the size of the filter matrix applied to the distribution curve Cd; an actual application of size difference between the distribution curve and the reference curve is not limited to the above-mentioned embodiment and depends on the design demand.

In the first embodiment, the distribution curve Cd and the reference curve Cr can be set from the same detection image Id. The present invention can compute a mean difference between all pixels of the distribution curve Cd and the reference curve Cr of each pixel group of the detection image Id, and compute a pixel difference between one pixel of the distribution curve Cd and a corresponding pixel of the reference curve Cr, and further compute a ratio of the foresaid mean difference to the foresaid pixel difference for deciding the predefined threshold; for example, the foresaid mean difference can be denominator, and the foresaid pixel difference can be numerator, and the ratio computed by one or some pixels that exceeds the predefined threshold can be defined as dirt (which means the image defect). In addition, the predefined threshold may be optionally set as the mean difference between all pixels of the distribution curve Cd and the reference curve Cr of each pixel group of the detection image Id; definition of the predefined threshold can depend on the design demand. In other possible embodiment, the reference curve Cr can be parameter distribution variation of each pixel group of a reference image. The reference image can be an image frame captured by the camera in the uniform illumination field when being just shipped from the factory and has no image defect; in this embodiment, the predefined threshold can be set as the mean difference between all pixels of the detection image Id and the reference image. That is to say, the reference curve Cr can be optionally set from the same detection image Id as the distribution curve Cd, or set from the reference image that has a different source than the distribution curve Cd; application of the reference curve Cr can depend on the design demand.

Please refer to FIG. 3 and FIG. 5. The detection image Id is acquired from the uniform illumination field, but a lateral area of the detection image Id may have intensity lower than intensity of a middle area of the detection image Id due to light divergence phenomenon. In order to overcome detection errors resulted from an illumination field edge effect, the image defect identification method of the present invention can preferably divide each pixel group of the detection image Id into an initial pixel set G1, a middle pixel set G2 and a rear pixel set G3. The middle pixel set G2 can be located between the initial pixel set G1 and the rear pixel set G3. A range of the middle pixel set G2 relative to ranges of the initial pixel set G1 and the rear pixel set G3 can depend on intensity distribution variation of the detection image Id. The operation processor 14 can transform the middle pixel set G2 into the distribution curve Cd, and execute the image defect identification method to determine whether the middle area of the detection image Id has the image defect. The lateral area of the detection image Id may have the image defect, and the operation processor 14 can utilize a transforming parameter or a transformation algorithm that is different to ones applied for the middle pixel set G2 to transform the initial pixel set G1 and the rear pixel set G3 into another distribution curve Cd“, and then compare the distribution curve Cd” with another reference curve and another predefined threshold for determining whether the lateral area of the detection image Id has the image defect.

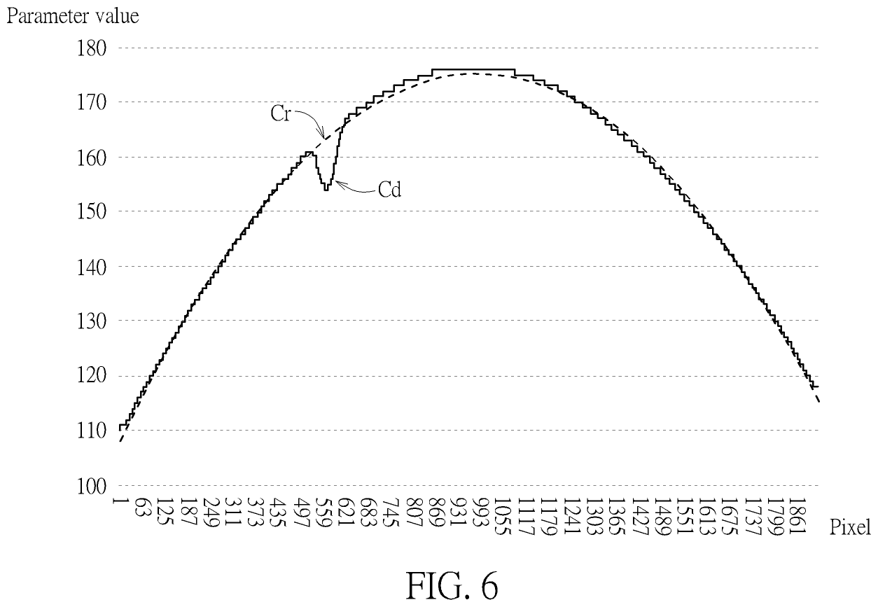

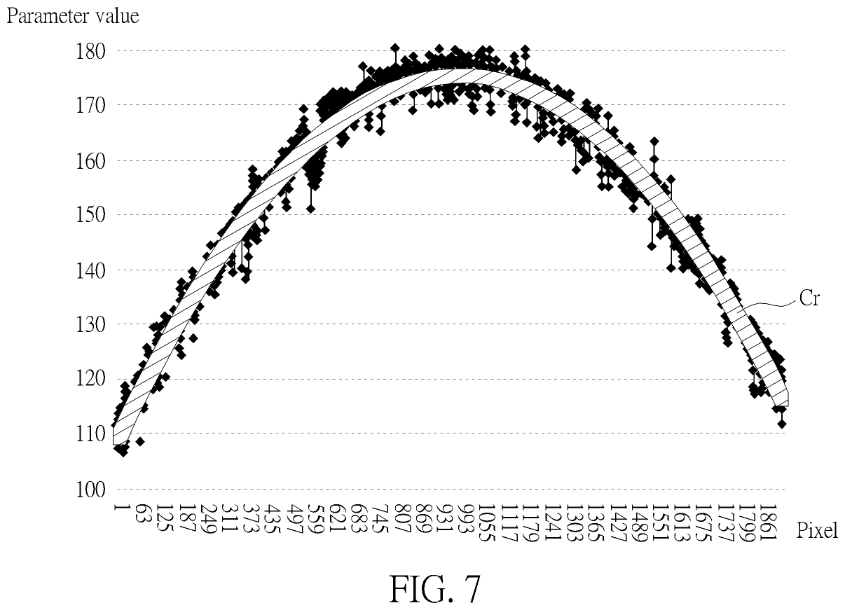

Please refer to FIG. 6 and FIG. 7. FIG. 6 is a diagram of a curve transformed from the detection image Id according to a second embodiment of the present invention. FIG. 7 is an intensity distribution diagram of one pixel group of the detection image Id according to the second embodiment of the present invention. In the second embodiment, the operation processor 14 does not transform each row or each column of pixels on the detection image Id by the filter matrix; the operation processor 14 can acquire pixel intensity distribution of each row or each column of pixels on the detection image Id to set as the distribution curve Cd, and further utilize a curve fitting algorithm to transform the foresaid row or the foresaid column of pixels into the reference curve Cr. Then, the image defect identification method can compare an intensity difference between the specific section of the distribution curve Cd and the related section of the reference curve Cr with the predefined threshold; as shown in FIG. 6, intensity of one or some sections of the distribution curve Cd that meets the image defect (such as the dark spot P) may be decreased severely, so that the present invention can analyze the intensity variation of pixels to find out the image defect.

As shown in FIG. 7, the camera may be affected by environmental factors or hardware parameters during capturing process of the detection image Id, and each row or each column of pixels on the detection image Id may have unknown noise or dead pixels. Therefore, the image defect identification method of the present invention can utilize the filter algorithm to remove noise of each row or each column of pixels on the detection image Id, and then acquire the distribution curve Cd from the set of pixels that has removed the noise and processed by transformation of the filter matrix and analysis of the intensity distribution, so as to compare the distribution curve Cd with the reference curve Cr for finding out the defect on the detection image Id.

As shown in FIG. 6, the second embodiment can set the intensity distribution of each row or each column of pixels on the image as the distribution curve Cd, and then acquire the reference curve Cr by the curve fitting algorithm applied to the distribution curve Cd; actual application of the distribution curve Cd and the reference curve Cr is not limited to the above-mentioned embodiment. In other possible embodiment, the image defect identification method of the present invention can set the intensity distribution of each row or each column of pixels on the detection image Id as the distribution curve Cd, and compute slopes of several sections of the distribution curve Cd. If a difference between the slope of the specific section and the slope of adjacent section conforms to a predefined condition, which means the slope is severely changed because of the image shadow or the image defect, the image defect identification method can determine the area of the detection image Id conforming to the specific section has the dirt. The scope of severe change in the slope is not defined in the present invention, which depends on the design demand.

In conclusion, the image defect identification method and the related image analysis device of the present invention can sequentially scan all rows or all columns of pixels on the detection image, and compute the distribution curve and the reference curve acquired from the transformation of the filter matrix or the analysis of the intensity distribution applied to each row or each column of pixels for comparison. The reference curve and the distribution curve may be acquired from the same detection image, or the reference curve may be acquired from another reference image rather than the detection image; however, the distribution curve and the reference curve can be preferably acquired from the same image. The image defect (such as the dark spot) may change intensity of related pixels on the detection image, which results in the unsmooth curve, so that two filter matrices of different sizes that both have a curve smoothing effect can be utilized to generate two curves which has different degrees of smoothness in the unsmooth area. The section difference between the distribution curve and the reference curve can be compared to analyze a range and a degree of the defect of the detection image, so as to effectively determine whether the lens or the image sensor of the camera is a defective product.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image defect identification method applied to an image analysis device with an image receiver and an operation processor, the image defect identification method comprising:
the operation processor dividing a detection image acquired by the image receiver into a plurality of pixel groups;
the operation processor transforming one of the plurality of pixel groups into a distribution curve;
the operation processor comparing the distribution curve with a reference curve; and
the operation processor determining an area of the detection image conforming to a specific section of the distribution curve has defect when a difference between the specific section of the distribution curve and a related section of the reference curve is greater than a predefined threshold.

2. The image defect identification method of claim 1, further comprising:
the operation processor generating the distribution curve by other transforming parameter and comparing the distribution curve with the reference curve to verify whether the area of the detection image conforming to the specific section has the defect when the difference is smaller than or equal to the predefined threshold.

3. The image defect identification method of claim 1, wherein the reference curve is defined as parameter distribution variation of any pixel group of a reference image, the predefined threshold is a mean difference between all pixels of the detection image and the reference image.

4. The image defect identification method of claim 1, further comprising:
the operation processor utilizing one filter matrix of Gaussian filter matrix, a mean filter matrix, a median filter matrix and a bilateral filter matrix to transform the foresaid one pixel group into the distribution curve.

5. The image defect identification method of claim 4, further comprising:
the operation processor further applying different matrix parameters into the utilized filter matrix to generate the reference curve.

6. The image defect identification method of claim 1, further comprising:
the operation processor computing intensity distribution of the foresaid one pixel group to set as the distribution curve, and further utilizing a curve fitting algorithm to generate the reference curve.

7. The image defect identification method of claim 1, further comprising:
the operation processor dividing the foresaid one pixel group into an initial pixel set, a middle pixel set and a rear pixel set; and
the operation processor transforming the middle pixel set into the distribution curve.

8. The image defect identification method of claim 1, further comprising:
the operation processor utilizing a transforming parameter or a transformation algorithm different from the middle pixel set to transform the initial pixel set and the rear pixel set into another distribution curve.

9. The image defect identification method of claim 1, further comprising:
the operation processor utilizing a filter algorithm to remove noise of the detection image, and transforming the foresaid one pixel group of the filtered detection image into the distribution curve.

10. The image defect identification method of claim 1, further comprising:
the operation processor computing a slope of the specific section of the distribution curve; and
the operation processor determining the area of the detection image conforming to the specific section of the distribution curve has dirt when a difference between the slope of the specific section and a slope of an adjacent section of the distribution curve conforms to a predefined condition.

11. An image analysis device comprising:
an image receiver adapted to acquire a detection image; and
an operation processor electrically connected with the image receiver in a wire manner or in a wireless manner, and adapted to divide the detection image into a plurality of pixel groups, transform one of the plurality of pixel groups into a distribution curve, compare the distribution curve with a reference curve, and determine an area of the detection image conforming to a specific section of the distribution curve has defect when a difference between the specific section of the distribution curve and a related section of the reference curve is greater than a predefined threshold.

12. The image analysis device of claim 11, wherein the operation processor is further adapted to generate the distribution curve by other transforming parameter and compare the distribution curve with the reference curve to verify whether the area of the detection image conforming to the specific section has the defect when the difference is smaller than or equal to the predefined threshold.

13. The image analysis device of claim 11, wherein the reference curve is defined as parameter distribution variation of any pixel group of a reference image, the predefined threshold is a mean difference between all pixels of the detection image and the reference image.

14. The image analysis device of claim 11, wherein the operation processor is further adapted to utilize one filter matrix of Gaussian filter matrix, a mean filter matrix, a median filter matrix and a bilateral filter matrix to transform the foresaid one pixel group into the distribution curve.

15. The image analysis device of claim 14, wherein the operation processor is further adapted to apply different matrix parameters into the utilized filter matrix to generate the reference curve.

16. The image analysis device of claim 11, wherein the operation processor is further adapted to compute intensity distribution of the foresaid one pixel group to set as the distribution curve, and further utilizing a curve fitting algorithm to generate the reference curve.

17. The image analysis device of claim 11, wherein the operation processor is further adapted to divide the foresaid one pixel group into an initial pixel set, a middle pixel set and a rear pixel set, and transform the middle pixel set into the distribution curve.

18. The image analysis device of claim 17, wherein the operation processor is further adapted to utilize a transforming parameter or a transformation algorithm different from the middle pixel set to transform the initial pixel set and the rear pixel set into another distribution curve.

19. The image analysis device of claim 11, wherein the operation processor is further adapted to utilize a filter algorithm to remove noise of the detection image, and transform the foresaid one pixel group of the filtered detection image into the distribution curve.

20. The image analysis device of claim 11, wherein the operation processor is further adapted to compute a slope of the specific section of the distribution curve, and determine the area of the detection image conforming to the specific section of the distribution curve has dirt when a difference between the slope of the specific section and a slope of an adjacent section of the distribution curve conforms to a predefined condition.
